(19) United States
(12) Patent Application Publication
(10) Pub. No.: US 2006/0154697 A1
(43) Pub. Date: Jul. 13, 2006

(54) Universal hands-free device for mobile phone with BLUETOOTH

(76) Inventors: Viktor Vasilievich Brailovskiy, St. Petersburg (RU); Dmitriy Mihailovich Gordeev, St. Petersburg (RU); Mikhail Evgenievich Smirnov, St. Petersburg (RU)

Correspondence Address: HOUSTON ELISEEVA, 4 MILITIA DRIVE, SUITE 4, LEXINGTON, MA, 02421, US

(21) Appl. No.: 11/314,854

(22) Filed: Dec. 20, 2005

(30) Foreign Application Priority Data
Dec. 20, 2004 (RU) 2004137291/22

(51) Int. Cl. H04M 1/00; H04B 7/00

(52) U.S. Cl. 455/569.1; 455/41.2

(57) ABSTRACT

The device relates to the field of mobile telephone connectivity and can be used during telephone communication, for example, while operating a motor vehicle. The universal hands-free device for a mobile phone with BLUETOOTH comprises a main block activating a receiving-transmitting BLUETOOTH module, and a detachable microphone electrically connected to it, a display block, a module for reading and storing data from the mobile phone's SIM card, and a remote control, optically connected to the display block. The module for reading and storing data from the mobile phone's SIM card can include a Universal Serial Bus (USB) port. The invention provides improved comfort and safety of using a hands-free device in vehicles with any mobile telephone that supports BLUETOOTH technology, as well as an opportunity for a user to place phone calls to contacts whose phone numbers are entered into the memory of the user's mobile telephone's SIM card, all while operating a motor vehicle and retaining control over the motor vehicle and the traffic situation.

### RELATED APPLICATIONS

This application claims priority to Russian patent application number 2004137291, filed Dec. 20, 2004, which is incorporated here by reference in its entirety.

### FIELD OF THE INVENTION

The invention relates to the field of mobile phone connectivity and can be used in cellular telephone communication using a mobile phone with BLUETOOTH, for example, while operating a vehicle.

### BACKGROUND OF THE INVENTION

It is known that a universal hands-free device for a mobile phone with BLUETOOTH (model <<UNI Chauffeur Talk 8501>>, technical description, issue 25.0820.0-06-170204, manufacturer THB Bury GmbH & Co. KG, www.thb.de), comprising a main block and a detachable microphone electrically wired to it, a display block activating a photodetector, transition module, receiving-transmitting BLUETOOTH module, made to permit an electrical connection with the transition module through a universal electric connector, and a remote control containing an infrared beam optically connected to the display block. One shortcoming of such a device is the difficulty of constructing it, arising from the presence of a transition module. Moreover, the described device does not provide for the possibility of reading and saving SIM card data from any mobile telephone with BLUETOOTH for future use of this data in outgoing and incoming calls, because the majority of existing mobile telephones with BLUETOOTH do not support the function of transferring SIM card data through a radio-frequency BLUETOOTH channel.

The closest to the proposed invention and chosen as the prototype is a universal hands-free device for a mobile phone with BLUETOOTH (model <<CK3100>>, technical description, issue V14/06/04, manufacturer Parrot S. A., www.say-parrot.com), comprising a main block, activating a receiving-transmitting BLUETOOTH module, and a detachable microphone electrically wired to it, and a display block equipped with control devices for placing a call.

One shortcoming of the prototype is the inconvenience of using it while operating a vehicle, arising from the inability to use the SIM card data from any mobile telephone with BLUETOOTH when receiving and placing phone calls, as well as the necessity of manually inputting the phone number with the control modes located on the display block, requiring the driver to remove his/her hands from the steering wheel and thus diminish control over the vehicle on the road.

### SUMMARY OF THE INVENTION

The problem solved by the present invention is the improved comfort and safety of using the device with any mobile telephone that supports the BLUETOOTH technology.

This problem is solved by achieving the following technical goal: allowing the user of the device to place phone calls by using a remote control to contacts, whose phone numbers are entered into the address book of the mobile telephone's SIM card, while operating a vehicle.

This technical goal can achieved by providing a universal hands-free device for a mobile phone with BLUETOOTH, comprising a main block activating a receiving-transmitting BLUETOOTH module, a detachable microphone electrically wired to it, and display block, which universal hands-free device is also equipped with a module for reading and storing data from the mobile phone's SIM card, as well as a remote control optically connected to the display block.

Moreover, in the present universal hands-free device for a mobile phone with BLUETOOTH, the module for reading and storing data from the mobile phone's SIM card may include a Universal Serial Bus (USB) port.

### BRIEF DESCRIPTION OF THE DRAWINGS

The substance of the invention is presented in the drawing sheet in which:

FIG. 1 shows a general view of the present universal hands-free device for a mobile phone with BLUETOOTH, and

FIG. 2 shows a schematic presentation of a function scheme.

### DETAILED DESCRIPTION OF THE PREFERRED EMBODIMENTS

Comfortable hands-free use of a mobile phone with BLUETOOTH in a motor vehicle presupposes the ability of a user to place phone calls to contacts, whose phone numbers are entered into the memory of the SIM card of the mobile telephone, while operating the vehicle and without losing control of the vehicle or getting distracted from the road. The mobile telephone with BLUETOOTH should also be located in a zone of radio frequency compatibility of the mobile phone's receiving-transmitting BLUETOOTH modules and the hands-free device. The standard for transferring BLUETOOTH data in general provides for the ability to use the data from the SIM card of the mobile phone with BLUETOOTH through a radio-frequency channel, but the manufacturers of most mobile telephones do not offer this capability in their models. Thus, the standard prototype device does not provide the universality of the hands-free device, i.e. the compatibility with any model of a mobile phone supporting BLUETOOTH technology in the form of enabling the placement of phone calls to contacts whose phone numbers are entered into the memory of the user's SIM card. Moreover, users of even those few telephone models with BLUETOOTH, which allow the transfer of data from the SIM card's address book to the prototype's memory, must remove their hand from the steering wheel in order to dial the number of their contacts, i.e. the prototype is not equipped with a remote control. These factors, taken as a whole, decrease the comfort and safety of using the prototype device while operating a vehicle.

The proposed invention provides an additionally installed module for reading and storing data from the mobile phone's SIM card, as well as a remote control, optically connected to the display block. The presence of the module for reading and storing data from the mobile phone's SIM card provides the user with the ability to enter into the device's memory data about his/her contacts (names, phone numbers) in advance, either through a built-in SIM card reader or with the help of a computer through a built-in Universal Serial Bus (USB) port, and then, having installed the SIM card into the mobile phone with BLUETOOTH, use it in normal mode to place and receive calls in accordance with instructions for mobile phone use. Data on the user's contacts, stored into the device's memory, can be displayed on the display block's screen. The presence of a remote control in a location convenient for the user, for example, mounted on the steering wheel of the vehicle in a way that the mentioned remote control activating the infrared beam would be optically connected to the device's display block, equipped with a photo receptor, allows the user to select safely and conveniently the phone number of a selected contact from the list displayed on the screen. This selection can further be accomplished by sending the appropriate commands from the remote control.

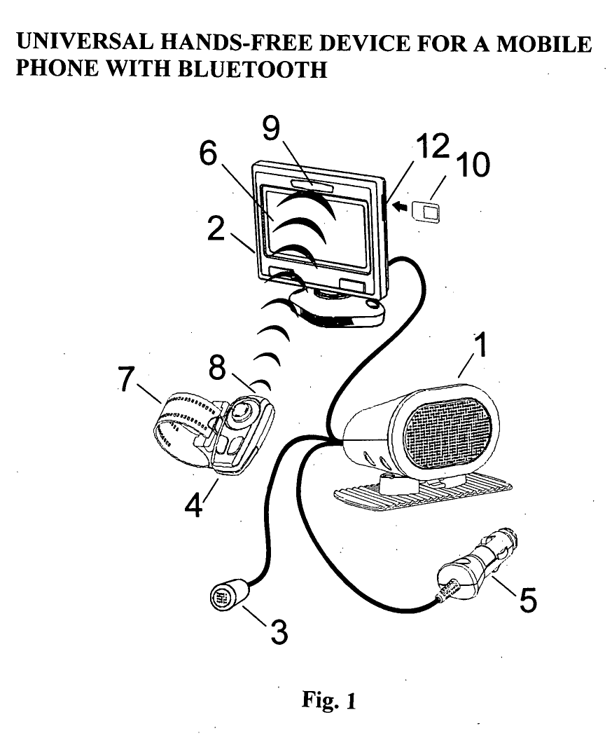

The present invention, whose general view is presented in FIG. 1, works as follows. Before the start of use, the main components of the device are positioned, installed, and connected in the cabin of the vehicle: main block 1, display block 2, detachable microphone 3, and remote control 4. Electricity is fed to the device from the vehicle's electric circuitry, e.g. adapter 5, electrically connected to main block 1. Display block 2 and detachable microphone 3 are connected to main block 1 by cables. Display block 2 is positioned in a place convenient to the user, for example, on the surface of the upper side of the dashboard's console directly in front of the driver's seat, so that screen 6 is clearly visible and display block 2 does not block the driver's view through the windshield. Remote control 4 is positioned in a place that is convenient for the user, for example, on the steering wheel of the vehicle, using the corresponding attachment device 7 and in accordance with the requirements of optical connection between the source of infrared beaming 8, positioned inside the remote control 4, and the photodetector 9, located inside display block 2. Detachable microphone 3 is located in a place convenient to the user at a distance not too far from his/her mouth, so that when the hands-free device is used and the vehicle is in motion, outside noises do not generate in the detachable microphone 3 electric signals comparable in amplitude to the electrical signals generated by the user's voice.

Also, prior to using the present invention, the user has the opportunity to record data from the SIM card 10 to the device's memory 11, using, for example, a SIM card reader 12 built into the device, after which the SIM card can be transferred into the mobile phone with BLUETOOTH 13.

To make a phone call, the user operates the control panel of the remote control 4 and, without removing his/her hands from the vehicle's steering wheel, through the optical communication channel between the remote control 4 and display block 2, formed through the infrared beam between source 8 and photodetector 9, issues. commands to processor 18, which accesses the device's memory 11, retrieves data, and conveys onto the display screen 6 a list of telephone numbers of contacts, previously entered into the device's memory 11. Having chosen the desired contact from the list, the user sends a command to dial the selected number. Upon establishing connection with the contact, the user can achieve comfortable and safe hands-free connection through the detachable microphone 3 and loudspeaker 14, built, for example, into the main block 1, or through the vehicle's own acoustic loudspeaker system, connected to the main block 1 of the device (not shown on the drawing). During the conversation, the mobile telephone with BLUETOOTH is located in a zone of radio-frequency connection with the receiving-transmitting BLUETOOTH module 15 of the hands-free device.

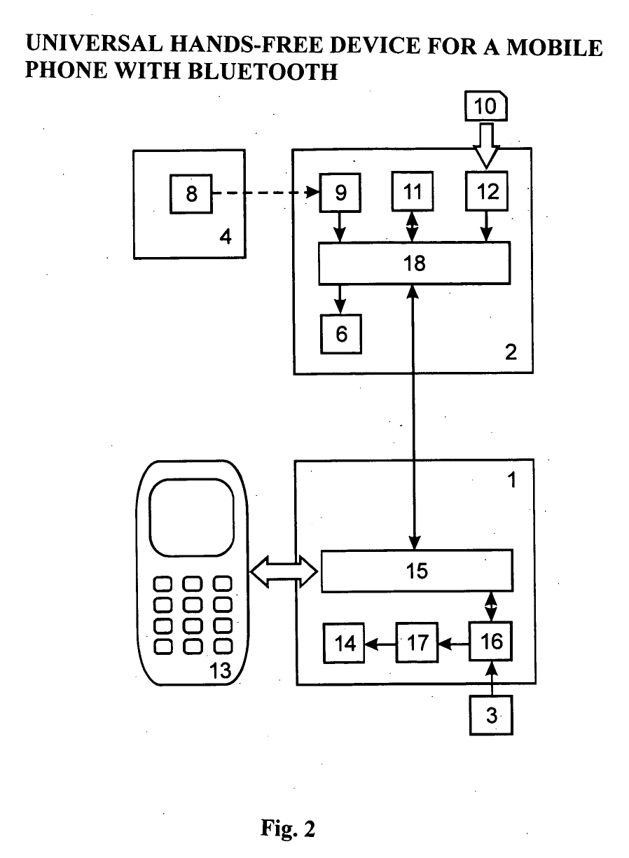

A functional scheme of the present invention in its preferred embodiment is shown in FIG. 2. The scheme depicts: main block 1, activating the receiving-transmitting BLUETOOTH module 15, electronic echo cancellation module 16, amplifier 17 and loudspeaker 14, display block 2, activating display screen 6, photodetector 9, SIM card reader 12, memory 11 and processor 18, detachable microphone 3, and remote control device 4 with infrared beam source 8. Functionally, the module for reading and storing mobile telephone SIM card data, including memory 11 and either SIM card reader 12 or, for example, a Universal Serial Bus (USB) port (not shown on drawing), can be either located in the display block 2, (as shown in FIG. 2), or in the main block 1 of the device. Regarding comfort and ease of use, the positioning of the module for reading and storing mobile phone SIM card data is preferable in display block 2, because this block is always located in an easily accessible and open place within the vehicle's cabin, while for main block 1 such requirements and location limitations are not necessary. Furthermore, display block 2 can be made detachable.

The presence of a Universal Serial Bus (USB) port in device of the present invention provides an opportunity to increase further the comfort and safety of using the device with any mobile phone supporting BLUETOOTH technology. For example, the device can additionally contain a receiving GPS (Global Positioning System) module, and information about the user's location will be shown on display 6, if previously corresponding map data is entered into memory 11. Computerized entry of such data into the device's memory 11 is preferable through a Universal Serial Bus (USB) port.

Thus, the proposed universal hands-free device for a mobile phone with BLUETOOTH provides improved use characteristics as well as enhanced comfort and safety of use with any mobile telephone supporting BLUETOOTH technology, through achieving the proposed technical goal: providing the user an opportunity to use a remote control to place calls while operating a motor vehicle to telephone contacts, whose phone numbers are entered into the phone book of the mobile telephone's SIM card.

What is claimed is:

1. A universal hands-free device for a mobile phone with BLUETOOTH comprising:
a main block having a receiving-transmitting BLUETOOTH module; and,
a detachable microphone electrically conencted to the main block;
a display block electrically connected to the main block, and a remote control optically connected to the display block; and
a module for reading and storing mobile phone's SIM card data disposed either in the display block or in the main block.

2. The universal hands-free device for a mobile phone with BLUETOOTH as in claim 1, wherein the module for reading and storing mobile phone's SIM card data comprises a Universal Serial Bus (USB) port.
